(19) United States
(12) Patent Application Publication
(10) Pub. No.: US 2017/0213281 A1
(43) Pub. Date: Jul. 27, 2017

(54) FINANCIAL METHOD PERTAINING TO BORROWING OF SHARES OF EQUITY BY THE ISSUER OF THE EQUITY

(71) Applicant: John Barthelow CLASSEN, Baltimore, MD (US)

(72) Inventor: John Barthelow CLASSEN, Baltimore, MD (US)

(21) Appl. No.: 15/326,835

(22) PCT Filed: Jun. 12, 2015
(86) PCT No.: PCT/US15/35523

§ 371 Date: Jan. 17, 2017

Related U.S. Application Data
(60) Provisional application No. 62/024,082, filed on Jul. 14, 2014.

(51) Int. Cl. G06Q 40/02; G06Q 40/06

(52) U.S. Cl. CPC G06Q 40/025; G06Q 40/06

(57) ABSTRACT

A method to assist in raising capital for an issuer of equity securities as well as generating interest payments for holders of equity securities issued by said issuer. The method includes use of a computerized HUB system including a computerized database and computer-readable code encoded on a computer readable non-transitory medium and which, when executed by a computer processor in the computerized HUB system, performs instructions to i) identify one or more shares of the equity securities previously issued by the issuer that may be available for the issuer to borrow, and ii) create a computerized database with data estimating and or documenting the number of equity shares that one or more potential lenders is willing to lend to the issuer at an interest rate or range of interest rates. The interest rate reflects collateral, the use of the proceeds to provide financing for the issuer, and/or the ability of the issuer borrower to repay the loan by issuing fungible shares to use as repayment.

### FIELD OF INVENTION

The present invention relates to the fields of corporate finance, investment banking, e-commerce, computer databases for storing and processing information for these transactions.

### BACKGROUND OF THE INVENTION

Corporate finance has been a fairly stagnant field with little innovation. The United Nation's Food and Agriculture Organization (FAO.org) compiled an extensive review on methods for entities to raise money. These methods include cash loans from banks, governments, and corporate partners. Entities in the past have raised money through issuing equity securities, preferred stock, bonds, convertible bonds and warrants. Stock options are typically issued as compensation for employees.

Issuing of the financial instruments described above is regulated in the US by the SEC, Securities Exchange Commission. The issuing is typically done in conjunction with an investment bank and is generally an expensive task. The issuing can be a private placement or a public placement. With public placements there is often a period where the investment bank seeks investors and when there is sufficient investor demand to meet the target fund raising, then the deal is completed. At times, particularly when the goal is to raise only a little money, an offering is made “At the Market”. The issuer alone or with an investment bank can sell new issues on the stock market in a piece mail fashion as demand develops. Private Placement of securities is typically done with an investment bank.

Prior to the current invention, stock borrowing was done for limited indications. Stock borrowing was done by investors who wanted to wager that a stock price would decline. Stock borrowing was also done when a stock sale needed to be completed by a certain date but the stock has not arrived to be transferred. A broker may borrow stock to complete the transaction and avoid the fines from an uncompleted trade. Stock borrowing and sale was also done for several other reasons in a transaction called “shorting against in the box.” Some investors who were long a stock would borrow fungible shares and sell them using their long shares as collateral. This was done for tax purposes to obtain cash immediately but defer the tax burden for subsequent years. Tax laws have irradicated this tax loophole. In rarer cases “shorting against the box” was used when an investor was prohibited from selling his or her own shares (or related long position, ie warrants) because of a contract and the investor would borrow other shares to sell short to hedge his or her long position.

A stock loan is governed by a “Securities Lending Agreement”. This agreement governs the terms of the loan and specifies the collateral the borrower will maintain for the loan as well as the interest payment. The collateral has typically been cash, government securities, or a Letter of Credit. The collateral for the Securities Borrow has not been an equal or greater number of unissued shelf registered or treasury fungible shares of Securities owned by the Issuer. The lender of shares receives an interest payment for lending shares. The interest rate reflects supply and demand of shares to be lent as well as risk of default in returning the shares. Prior to this invention the interest rate did not reflect the Borrow of Securities by the Issuer using unissued shelf registered or treasury shares as collateral and did not reflect the use of the funds by the Issuer-Borrower for corporate finance. The Borrow did not have a specified duration and penalties if the Securities were returned early. The “Securities Lending Agreement” did not have stipulations for lines of credit (to lend shares) and stipulations for interest payments based on a fixed value of the Security and or fixed interest rate. The ability of an Issuer-Borrow to issue new shares to repay the Borrowed Securities decreases the default risk and will be reflected in the interest payment the Lenders demand. The use of the funds for financing business growth can lead to appreciating of the shares of Securities owned by the Lender and this will be reflected in the interest rate.

Prior to this invention issuers of stock have used treasury stock as collateral for borrowing cash from lenders, but not borrowing stock. The amount of cash borrowed would be a fraction of the value of the collateral stock, such as 80%. If the value of stock used as collateral went down then under a typical loan agreement the company would have to provide more assets as collateral for the cash loan.

Inventors have obtained business method patents regarding business methods in the field of investment. The case State Street Bank and Trust Company v. Signature Financial Group, Inc., 149 F.3d 1368 (Fed. Cir. 1998) regarding U.S. Pat. No. 5,193,056. Since this case, numerous patents have been filed covering inventions relating to financial transactions. However none, to the inventor's knowledge, cover a HUB or method to facilitate an Issuer in borrowing its own equity Securities and then selling the borrowed equity Securities for the purpose of financing its operations while lowering its cost of capital.

### SUMMARY OF THE INVENTION

The present invention involves the a method of corporate finance and the creation of a computerized financial HUB to facilitate an Issuer of the equity Security (called “Security” herein) in borrowing its previously issued equity securities. The transaction acts to greatly reduce the cost of capital to an Issuer of equity Securities. The HUB facilitates a issuer of a equity security in Borrowing a Security it has previously issued in order to raise capital by selling the Borrowed Security. The HUB facilitates the transaction by performing computations (or obtaining computations made by others), storing and transmitting data helpful in initiating and or completing this transaction.

The present invention relates to creation of an method of corporate finance and a computerized financial HUB to facilitate an Issuer of equity Securities to Borrow previously issued equity Securities from investors in the Securities (those entities claiming ownership of the securities) or those in a position to loan the Securities (though they might not own the security this right to loan shares occurs because of contractual relationships). The Securities for example could include stock certificates or derivatives of stock certificates including ADRs (a tradable derivative of a foreign equity). Those potentially lending the Securities could include the non-limiting examples: individual investors, corporate entities investing in the security, brokerages houses, agents or depositories holding securities for an investor, trusts, governments or funds such as mutual funds, hedge funds, or index traded funds. Potential Lenders of the Security could include third parties who have possession of the Securities after Borrowing the Security from the owner.

The HUB facilitates the Issuer of the Security in Borrowing the Security and can help potential Lender of the Security in lending the Security. Thus the HUB can help potential Issuer-Borrowers and Lenders find each others and facilitates the Security Borrow. The HUB's acts of facilitation may include some or all of the following: setting the terms of the Borrow, recording the transaction, reporting the transaction to the appropriate regulatory body such as FINRA or SEC if required, ensuring the transaction is in compliance with all state and federal laws, assuring all parties understand the risks of the transaction and record keeping. The HUB may act to ensure the Issuer-Borrower maintains appropriate collateral for the Borrowed Securities. In cases where the collateral is fungible Securities, as in the non-limiting examples of as unissued securities/shelf registered securities, treasury stocks, or a promiscurory note to provide fungible securities, the HUB may act as a depository, keeping the collateral in its possession to assure the Lender(s) it has access to the collateral when the permitted under the terms of the contract. The Issuer-Borrower can also use other assets as collateral as in the non-limiting examples of cash, unrelated securities or tangible assets to borrow its equity Securities.

The HUB may sell to the MARKET the Borrowed Securities for the Issuer-Borrower and give the Issuer-Borrower the proceeds minus any expenses, fees, interest and signing bonus due to the Lender and the HUB. The HUB may facilitate the payment of interest (and dividends when applicable) to the Lender(s). At the end of the Borrow the HUB may purchase Securities from the MARKET to repay the Lender(s) alternatively the HUB may assist the Issuer-Borrower to issue fungible shares to repay the Lender(s).

The HUB may perform a number of computations or collect financial information to provide to either the Lender or Issuer-Borrower. The HUB may collect information on the short position of the stock as a percent of the float or relative to any other financial parameter (the following non-limiting examples: total outstanding shares, total shares floating, market capitalization, total dept, enterprise value, shares available to Borrow). Those skilled in the art know databases and providers (for example custodial banks) who have data on who owns shares of specific companies.

The methods and HUB described here in and claimed in this document can cover the non-limiting examples: an Issuer-Borrower, Lender, or third party investment bank (regardless of what the organization calls itself) utilizing the described method or setting up the HUB to raise capital, conduct business, or lend stock.

### DESCRIPTIONS OF THE DRAWINGS

FIG. 1 is a schematic view of a first embodiment of a system according to the present invention;

FIG. 2 is a schematic view of a further embodiment of a system according to the present invention;

FIG. 3 is a schematic view of a further embodiment of a system according to the present invention;

FIG. 4 is a flow chart illustrating the method according to the present invention; and

FIG. 5 is a schematic of a computerized financial HUB according to the present invention.

### DETAILED DESCRIPTION OF THE INVENTION

The present invention involves the creation of a computerized financial HUB to greatly reduce the cost of capital to an Issuer of Securities. FIG. 5 illustrates schematically the relationship between the HUB, an Issuer-Borrower, a Lender and the MARKET. The HUB facilitates an Issuer of a “equity security” (called “Security” herein) in Borrowing a Security it has previously issued in order to raise capital by borrowing and selling the borrowed security. The HUB facilitates the Borrow by performing the computations (or obtaining computations from others), storing and transmitting data useful for the initiation or completion of equity Security Borrow transactions.

The Parties

Issuer-Borrower of Securities: a corporate entity that issues equity Securities to investors and then Borrows the Securities back

Lender of Securities: an entity or a group of entities (such as a syndicate) that owns or has the ability to lend Securities issued by the Issuer-Borrower

HUB: an intermediary acting on behalf of the Issuer-Borrower of Securities and or the Lender to facilitate the Borrow of Securities. Ideally, and if permitted by regulatory agencies, the HUB acts on behalf of both the Issuer-Borrower and the Lender.

Market: one or more investors who buy or sell Securities

Regulatory Bodies: any government or independent group that oversees financial transactions including the non-limiting examples of the SEC, FINRA. The Regulatory Bodies also includes government agencies that collect tax information and or taxes from financial interactions

The Transaction

Securities: as used here in, Securities refer to equity securities (as in the non-limiting example of common stock) or derivatives of equity securities (as in the non-limiting example of an ADR, American Depository Receipt)

Borrow: a transaction, regardless of what it may be called, where the Borrower gains access to Securities but is obligated to provide the Lender with said Securities in the future. The Borrow is not limited to the exact same note, only an equivalent note (fungible Security)

The Role of the HUB

The HUB may seek to identify potential Issuer-Borrowers that may benefit from the Security Borrow. The identifying can be performed using any single or combination of the non-limiting parameters: finding a company with substantial public float of its equity shares (either or both in absolute value or as a percent of total issued shares), which has cost of capital above 1% (preferably above 2%, more preferably above 3%), which may have substantial debt and interest payments (either or both in absolute value or as a percent of total value of the company, or as a percent of sales, earnings, cash flow, cash reserves), which may have a low or no dividend payment based on its share price, where there is a sizable percent (greater than 5, 10, 15, 20, 25, 30, 35, 40, 45, 50) of equity shares are held by institutions likely to lend their shares (index funds, mutual funds, insurance companies). Ideally in the non-limiting example the company would have high costs of capital, a high debt risk that the company may want to lower, a large % float of stock, no dividends, where over 50% of the shares are held by institutions willing to lend Securities at less than 1% per year. The HUB may seek potential Issuer-Borrowers by many ways including the non-limiting examples of looking at firms listed on stock indexes like DOW, SP-500, or industry specific indexes or an stock exchange as in the non-limiting example of NASDQ, NYSE. One skilled in the art will, upon reading this, know that some companies may benefit more than others however all firms with equity Securities may benefit from the Securities Borrow especially those with large public floats. One skilled in the art knows databases and data providers who can provide the data to be analyzed by the HUB.

The HUB may seek to identify potential Lenders that may benefit from the Security Borrow and where the economics to the HUB would be positive. The Lender could be a large depository bank that holds shares for the owner and has the right to lend the shares. The Lender can also be the owner of the stock as in the non-limiting examples of a trust, mutual fund, hedge fund. The identifying of the potential Lender can be performed using any single or combination of the non-limiting parameters: holds a sizable amount of a Security, the amount of the Security held over time is predictable, no expectations in the foreseeable future of exiting its position (for example an index fund may divest from a stock which gets delisted from an index, for example SP500), Lender's returns are not substantially better than competing funds, Lender has low leverage, low turnover of stock positions, investor base is not transient, management has the interest and time to lend, small percent of Security already lent out to short sellers. One skilled in the art knows databases and data providers who can provide the data to be analyzed.

The HUB may facilitate the Securities Borrow in several ways. The HUB may facilitate the Issuer-Borrower in Borrowing the Securities by taking orders from the Issuer-Borrower and finding Lenders to complete the Borrow. The HUB may also take offers to Lend Securities from a Lender and find Issuer-Borrowers who want to Borrow their Securities. The HUB may additionally sell the Borrowed Securities for the Issuer-Borrower to the Market. The HUB, during the repayment phase, may buy Securities from the MARKET so the Issuer-Borrower may repay the Securities to the Lender or assist the Issuer-Borrower in issuing new fungible Securities to be used as repayment.

The Issuer-Borrower may keep appropriate collateral for the Borrowed Securities. The collateral may include treasury stock, unissued shares/shelf registered shares (as used herein shelf registered shares are meant to be shares that have not been issued), promissory note to issue fungible shares as payment if needed, or other assets including the non-limiting examples of cash, marketable securities, tangible assets or insurance to cover some if not all of the value of the borrowed shares. Preferable the collateral will be in the form of unissued shelf registered shares and are the same type as the Borrowed shares, i.e., fungible Securities. The HUB may assist in the creation of the collateral by assisting in having the collateral Securities shelf registered and maintained shelf registered.

The HUB may facilitate the Borrow of Securities by any of the following: mediating a contract (for example terms) between the Issuer-Borrower and the Lender, assuring the terms of the contract are met including assuring that the collateral exist and is maintained. The HUB may optionally (depending on the terms of the Borrow contract) make sure that the Lender can gain access to the Securities in a timely fashion if the Lender needs to regain control of the Securities.

Financial Information

The HUB may gather, store and or provide financial information to a potential Issuer-Borrower to help determine if a Securities Borrow would likely be successful in raising the desired amount of capital at acceptable terms (interest rate, impact on share price, risk of default, and other factors described below). The HUB may optionally facilitate the Borrow by providing financial information to help the Issuer-Borrower determine how many shares of Securities the Issuer-Borrower may want to Borrow and the duration of the Borrow. The HUB may perform calculations, compile information or provide calculations or information compiled by others on the expected price or expected market value of the Securities, the expected (or preferred) rate of selling the shares of Security to the Market, and the expected (or preferred) rate of buying the securities from the Market to repay the loan. The HUB may provide data to estimate how much revenue the Securities may bring when sold to the Market. The HUB may provide data on how long it will take to sell the Securities.

In order to facilitate the Borrow the HUB may estimate the potential effect of the Borrow on the Securities' price and create a plan to minimize any negative impact on the share price of the Security. These calculations and compiled information will help determine how successful a future Securities Borrow may be. In contrast to an entity shorting stock on a bet the share price will go down, ideally in an Securities Borrow initiated by an Issuer-Borrower the plan is for there to be minimal negative impact on the Security share price. The HUB may perform calculations, compile data or obtain calculations and data from others (as in the non-limiting example of contractors or data vendors) on how a future Borrow is expected to impact the share price. The HUB may use historical data on the sales of the Issuer-Borrower's Security to estimate the impact of the increased sales of the Security following a Borrow (the Borrowed Securities when sold to the Market would be expected to increase sales volume on the Market) on the Security share price. The HUB may also use data from comparable companies to study the effect of increased sales volume on share price of the comparable company's Security. The data analyzed to predict the impact of the Borrow on Security price may include the non-limiting examples of comparisons on the size of the Borrow (as in the non-limiting examples of number of shares, the ratio of the number of shares relative to number of shares floating or relative to the number of shares issued; the value of the total Borrow, the ratio of the value of the Borrow relative to the market capitalization of the company or relative to the enterprise value of the company), the price of the Securities at the time of the Borrow, the number of shares of Securities floating at the time of the Borrow, the daily/weekly/monthly/yearly volume of the Security traded, the number of Lenders, the profitability of the company, the amount of outstanding dept of the company, the cash flow of the company, the prior growth of the company (as in the non-limiting example of sales growth, profit growth, asset growth). The HUB may perform a multivariate analysis or other statistical analysis using one or more of the factors.

The HUB may calculate estimates of the Market reaction to the sale of the Borrowed Security, the expected rate of decline in Security price resulting from the increased number of shares being sold in an period of time. This estimate may be made based on prior responses of the Market to sale of the Issuer-Borrower's Securities as in the non-limiting example of either prior Security Borrows, prior new issuance of shares, or prior fluctuations in volume increases in Security sales or based on market responses to similar events with comparable companies' shares of Securities. The comparable company could be a company with any one or more of the following non-limiting examples: similar market capitalization, similar enterprise value, similar number of shares floating, similar share price, similar earning, similar sales, similar dept, similar growth or expected growth, similar industry. The HUB may also perform small Securities Borrow transactions of the Issuer-Lender's shares to determine market reaction on Securities price. Based on the results the Issuer-Borrower can plan on larger follow on transactions or postpone plans for further Securities Borrow. The HUB may use any relevant statistical tool to estimate the impact of the Borrow on the Securities price. There are many skilled in the art of statistics that know how to apply statistical tools and countless statistical publications on this topic.

The HUB may facilitate the Borrow by compiling information, performing calculations or obtaining information from third parties and providing it to help the Lender determine a preference or range on how many shares of Securities it should lend and or the Issuer-Borrower should borrow. The HUB may compile information, perform calculations or obtain calculations and or compiled information from others (as in the non-limiting examples of contractors or data venders) on any of the following non-limiting examples: historical redemption rates in the fund, redemption rates in comparable funds (as in the non-limiting example of funds investing in similar companies or market sectors, funds with a similar mix of investor, funds of similar size, funds with a similar investment strategy, funds with a similar mix of investments such as bonds, cash, equity), likely trends (bull or bear market) in the market or sector of the market that could impact redemption rates as well as trends such as shifting funds from high fee actively managed funds to low fee passively managed (index or ETF) funds. The HUB can also track the proportion of Securities that comparable funds are holding in reserve (not lending out) and cash reserves in case investors decide to ask for redemptions. One skilled in the art knows how to gather information for a potential securities investment banking deal and for traditional short sales used by investors betting against a company. Similar techniques can be employed. One can contact holders of Securities or their agents to find who is interested in lending Securities and the number of Securities according specific terms of the Borrow. The information from the initial survey can be used to finalize the terms of a Security Borrow that provides terms suitable to both the Lender and Issuer Borrower and provides enough shares to the Issuer-Borrower that the Issuer-Borrower decides to finalize the deal. The HUB can also gather or store information on previous Security Borrows to estimate the likely interest rate and terms that a potential Lender will desire in order to participate in an Security Borrow. This information may be categorized based on Security Borrows of comparable companies (as defined earlier). In some instances the Lenders in previous Security Borrows will be potential Lenders in Borrows involving different Issuers. Information can be stored and categorized based on terms that these potential Lenders are agreeable to.

Calculations or Information that May be Provided by the HUB

In conjunction with the Financial Information role described above, The HUB may perform specific calculations or provide information related to these calculations and or to allow the Lender or the Issuer-Borrower to determine how many or a range of shares to lend or Borrow (respectively), or how successful the Securities Borrow is likely to be. The HUB may provide the following calculations or calculate the inverse relationships of these. One skilled in the art understands inverse relationship of a ratio provides the same information in a different format. The HUB can perform the calculations or have others (as in the non-limiting example of contractors, data vendors) perform the calculations for the HUB. Relevant statistical tools can be used when appropriate. These calculations can be used to make circuit breaker orders or parameters as discussed elsewhere. The preferred ranges are not intended to be absolute requirements for a Borrow but information that can help guide decisions on a case by case basis. While at times some parameters may not be in a preferred range this must be held in light that other parameters may be in very favorable ranges. One skilled in the art understands that any calculation described below can be performed for any party including Borrower, Lender, or other regardless of the subheading below. While preferred ranges are provided these are not intended to be absolute limits of a claim, as an circuit breaker can be set using any range of per cents from 0.000001% to 1,000,000,000,000%

For the Issuer Borrower
Ratio of the number of shares of Security short, before the Borrow, relative to the number of shares of Security floating
   Preferably less than 50%, more preferably less than 20%, more preferably less 5%
Ratio of the number of shares of Security short, before the Borrow, relative to the number of shares of Security issued
   Preferably less than 50%
Ratio of the number of shares of Security Borrowed (or to be Borrowed) relative to the total float of the Security
   Preferably less than 50%
Ratio of the number of shares of Security Borrowed (or to be Borrowed) relative to the number of shares of Security issued
   Preferably less than 50%
Ratio of the number of shares being Borrowed relative to the number of shares that potential Lenders are willing to Lend at the specified terms
   Preferably less than 90%, more preferably less than 80%, more preferably less than 70%, more preferably less than 60%
Ratio of the value of Security Borrowed (or to be Borrowed) relative the total market capitalization of the Issuer-Borrower
   Preferably less than 50%
Ratio of the value of Security Borrowed (or to be Borrowed) relative to the company's total debt
   Preference will depend on the company
The combined old debt and new liability (after the Borrow) of the Issuer-Borrower
   Preference will depend on the company
The ratio of the combined old liabilities and new liabilities after the Borrow relative to the old liabilities
   Preference will depend on the company
The ratio of the value of the Borrow relative to book asset value of the Issuer-Borrower
   Preference will depend on the company
The ratio of the value of the Borrow relative to net income of the Issuer-Borrower
   Preference will depend on the company
The ratio of the value of the Borrow relative to gross income of the Issuer-Borrower
   Preference will depend on the company
The ratio of the value of the Borrow relative to sales of the Issuer-Borrower
   Preference will depend on the company
The ratio of the value of the Borrow relative to EBITA of the Issuer-Borrower
   Preference will depend on the company
The ratio of the value of the Borrow relative to profit or loss of the Issuer-Borrower
   Preference will depend on the company
The number of shares of the Security to be Borrowed relative to the daily/monthly/semiannual/annual number of shares of the Security traded
   Preference less than 100% the annual volume of shares traded, preferably less than 20%, preferably less an 10%, Preferably less an 1%, Preferably less an 0.01%, preferably less than 0.0001%
The percent of shares floating controlled or owned by institutions
   Preferably institutions should hold at least 5% of the float of the Security to be Borrowed, more preferably 10%, more preferably 20%, more preferably 40%, more preferably 60%, and more preferably 80%
The ratio of the number of shares of Security to be Borrowed relative to the number of shares held by institutions
   Preferably the number of shares of Securities to be Borrowed at one time should be less than 95% of the number of securities held by institutions, more preferably less than 85%, more preferably less than 75%, preferably less than 50%
Number of Lenders or Potential Lenders
   Preferably more than 1, more preferably 2, more preferably 5, preferably 10 or greater
Turnover Rate or (Ratio): an increase or decrease in shares (or percent of shares) held by one or more holders over a specific time, as in the non-limiting example of years
   Preferably and investor will not decrease its holdings by more than 5% per year.
Number of shares one or more potential lenders is likely or will lend at a interest rate or range
   Preferably 100,000 more preferably 1 million, preferably 10 million, preferable 100 million
The interest rate of the equity Borrow relative to the expected interest in a comparable debt issue such as a bond or loan (expressed in absolute terms or a ratio)
   Preferably lower by an absolute amount of 1%, more preferably by 2% or greater
The interest rate of the equity Borrow relative to the mixed cost of capital of the Issuer-Borrower (expressed in absolute terms or a ratio)
   Preferably lower by an absolute amount of 1%, more preferably by 2% or greater.
The interest rate of the equity Borrow
   Preferably less than 20%, more preferably less than 10%, more preferably less an 5%, more preferably less than 2%
The interest rate of the equity Borrow
   Preferably less than the interest rate to the Issuer-Borrower for a similar size cash loan for a similar duration
The effective interest rate in a Dividend paying Security: interest of the Borrow plus the dividend yield
   Preferably less than 20%, more preferably less than 10%, more preferably less an 5%, more preferably less than 2%
   Preferably less than the interest rate to the Issuer-Borrower for a similar size cash loan for a similar duration
The Dividend yield
   Preferably less than 10%, more preferably less than 4%, more preferably less than 2%, more preferably less than 1%

### Calculations for the Lender

The ratio of the number of shares of Security to be Borrowed from the Lender relative to the Lender's total shares of the Security
   Preferably less than 95%, preferably less than 90%, preferably less than 80%, preferably less than 70%, preferably less than 50%
The ratio of the value of shares of the Security to be Borrowed from the Lender relative to the value of the Lender's total assets
   Preferably less than 95%, preferably less than 90%, preferably less than 80%, preferably less than 70%, preferably less than 50%, preferably less than 25%
The ratio of the value of shares of Security to be Borrowed from the Lender relative to the value of the Lender's total cash position and value of the Lender's total shares of the Security (for all funds and or (a) specific fund(s))
   Preferably less than 95%, more preferably less than 85%, more preferably less than 75%, preferably less than 70%, preferably less than 50%
The ratio of the total value of shares of Security to be Borrowed from the Lender relative to the value of Lender's net redemption rate over a period of time (day, week, month)
   Preferably less than 50% of the annual net redemption
The ratio of the interest to be earned by the Lender relative to the Lender's prior annualized (1 year and or more than one year) returns
   Preferably 1%, more preferably 5%, more preferably 10% or more
      Calculations for Sale to and Purchase from the Market
The number of shares of borrowed Security sold on the Market in one day
   preferably less than 20 times (or the equivalent %) the historical daily trading volume, more preferably less than 10 times, more preferably less than 2 times
The number of shares bought on the Market to repay the borrow, in one day is
   preferably less than 20 times (or the equivalent %) the historical daily trading volume, more preferably less than 10 times, more preferably less than 2 times
The share price of the Security sold
   preferably not less than 90% of the borrowed price, more preferably not less than 95% of the borrowed price, even more preferably not less than the borrowed price
The preferred time (days market open) frame to sell the Security is calculated by dividing the shares Borrowed by the preferred daily volume sold
The preferred time (days market open) frame to buy the Security to be returned at the end of the Borrow is calculated by dividing the number of shares Borrowed by the preferred daily volume bought
Preferably the daily volume of shares of Security from the Borrow being sold on the Market is decreased if the extra sales volume is associated with a decline in share price of 50%, more preferably 30%, more preferably 20%, more preferably 15%, more preferably 10%, more preferably 5%
Preferably the daily volume of shares of Security from the Borrow being repurchased on the Market is decreased if the extra sales volume is associated with a rise in share price of 50%, more preferably 30%, more preferably 20%, more preferably 15%, more preferably 10%, more preferably 5%

### Contract Creation

The HUB may optionally create the contract between the Issuer-Borrower and the Lender and include any terms/conditions the parties desire. One term of the contract is interest. The interest of the Borrow can be due periodically (as in the non-limiting examples of quarterly, semi-annually, annually) or at the end of the loan. The interest may be shares of Securities or it may be cash or cash equivalent. For example if the Issuer-Borrower borrows 100 shares (worth $100 dollars total) at 1% interest, the Issuer-Borrower would have to pay 1 share under a share interest based contract or $1 under a cash interest based contract.

Another tenet of the contract of the Borrow is whether all the shares will be Borrowed at the same time (specified in the contract) or whether the Borrow will resemble a line of credit where some of the shares can be Borrowed at the onset and optionally others can be Borrowed later.

For calculating cash interest payment, the Securities may be priced at the time they are Borrowed. In a fixed price loan, all shares of Security may be priced at the same cash value (often at the time the agreement is signed). Alternatively in a floating price arrangement Securities may be priced at the time a short sale is made. In such an arrangement the price of the Borrow is matched to the Market value at time sold. The advantage to the Issuer-Borrower of the floating rate is avoiding the scenario of simply Borrowing the Security at one price and then selling it later at a lower price. Fixed or floating price arrangements can be made to cover follow on borrows when subsequent shares are borrowed. Subsequent borrows can be made as part of a “line of credit” deals or when the Issuer-Borrower needs additional shares because a Lender has requested its shares back before the intended completion term of a deal.

### Record Keeping Roles of the HUB

The HUB may optionally create and store data related to the transactions between any of the following: the Issuer-Borrower, Lender, HUB, Market, Regulator Bodies. The following are non-limiting examples of the data that may be created, processed and or stored by the HUB:

Borrow Transactions (and or willingness to participate in a borrow) for one or more lenders: Terms of the Borrow, type of Securities (to be) Borrowed, number of shares of Security (to be) Borrowed, dates of the Borrow, interest paid to date, interest due, date of next interest payment, fees/interest owed to the HUB, shares repaid, shares owed. To clarify the Hub may record and or calculate the willingness or commitment of one or more potential Lenders to lend one or more shares at a interest rate or range of interest rates, according to specific terms. One skilled in the art understands that the interest rate that a potential Lender demands reflects supply and demand for a specific investment vehicle as well as risk of the investment. One skilled in the art understands risk reflects in part on what the loan would be used for, and what collateral is being used to secure the loan. Risk also reflects loan covenants such as rights of the Lender to ask for the loaned shares back and priority on when a share can be called back (as in the example where the Lender must recall shares from other classes of borrowers before requesting shares back from the Issuer-Borrower). The interest rate can also reflect covenants that the Lender must lend additional shares at a fixed or variable interest rate at a fixed or variable value of the share. The HUB can also record the planned duration of the loan as in the non-limiting examples of 6 months, or any yearly interval between 1-40 years as in 1 year, 2 years, 4 years, 6 years, 10 years, 20 years or more. The “Securities Lending Agreement” between the Lender and Issuer-Borrower may commit the Issuer-Borrower to Borrow the Securities for a minimum period of time, including the time frames in the previous sentence. Under this agreement if the Issuer-Borrower returns the Borrowed Securities early (before the agreed upon term) the Issuer-Borrower is committed to pay an agreed amount (this could be called interest or penalty or something else).

Voting Rights: Some potential lenders may be persuaded to lend shares or a bigger proportion of their shares if the Issuer-Borrower allows them to retain voting rights for at least some of the shares being lent. The HUB can record those potential lenders who desire to retain voting rights as well as those lenders who have retained voting rights and how much (numerical amount) of voting rights they have retained. A premium as in higher effective interest rate may be offered to potential lenders who lend their shares without retaining voting rights.

The Sale Transaction Order: The price range for the Security to be bought or sold on the Market, the time frame to complete the transaction.

Market Transaction: Number of shares of Security sold to or bought from the Market, the buyer or seller (other party in the transaction), the date of the transaction, the price paid.

Tax and or Accounting Information: Revenue generated from the sale of Securities or funds utilized to buy Securities, commission/expenses related to the transaction. Amount of taxes owed.

### Compliance Roles of the HUB

The HUB may optionally keep records needed for compliance with federal and or state laws. These laws include laws regulated by the SEC (Securities and Exchange Commission). The HUB may keep records for other agencies as in the non-limiting examples of those regulating collection of taxes, money laundering. The laws may apply to the HUB as well as the transactions that are performed in part by the HUB. Often a self-regulatory body including FINRA helps ensure that the mechanisms are in place at a firm to ensure the firm is in compliance with the laws. The HUB may keep records to be compliant with the law. Such information may include personnel information to ensure every one working with the HUB has the appropriate licenses, that the personnel provide the appropriate disclosures annually, that the appropriate continuing education and training is performed, that appropriate manuals and forms are provided to employees, and that employees have gone through background checks.

The HUB may collect and or maintain all the appropriate records of the transactions run with the assistance of the HUB as required by the law.

### Possible Interactions Between the HUB and the MARKET

The HUB may optionally sell the Securities to the Market for the Issuer-Borrower and when the shares are to be repaid to the Lender, the HUB may buy shares back from the Market. Unless contractually bound, the Issuer-Borrower has the final control over the terms of the sale of the shares and the buy back if this occurs (Of note the Issuer-Borrower may issue new shares of the Securities to repay the Securities to the Lender, and may not be obligated to buy the shares back from the Market). The Issuer-Borrower may dictate the price of the Securities to be sold to or bought from the Market. The Issuer-Borrower may dictate the time the transaction must be completed and or the number of shares of Security to be sold per day/week/month/year. These parameters may be dynamic and dictated based on a formula that involves the change in the share price to prevent the increased volume of shares sold as a result of the borrowing from depressing the share price. This process is known as a circuit breaker. For example shares may be sold more quickly if the price of the Security does not depreciate during a sale. The circuit breaker order could include orders based on decreasing the rate of selling shares (shares sold per day) or a halt on selling any shares below a fixed price. Different prices could be set at different days in the event of a declining market for example. There could be an circuit breaker to only sell a set number of shares at a set price. A similar circuit breaker could be employed to control the purchase of Securities from the Market or even issuing of new Security to pay back the loan. Circuit breaker parameters can also be set up to limit the amount of Security Borrowed from a single Lender to ensure the Lender can timely respond to redemption requests.

### Fiduciary Responsibilities/Capabilities of the HUB

The HUB may optionally have specific responsibilities to ensure the Security Borrow contract goes to completion and that both parties complete their obligations. The HUB may insure that there is ample collateral to repay the Lender in case the Issuer-Borrower has financial hardship. In a preferred case where the collateral is shelf registered fungible Security shares, the HUB may have the responsibility to ensure these shelf registered shares do not expire and are maintained in a depository. It is contemplated that “fungible shares” at times could include convertible notes or shares that convert into a fungible share at the Lender's option so the Lender can be made whole. The HUB may have responsibility to make sure the Issuer-Borrower pays the specified interest at the designated times. If the Issuer-Borrower defaults on the interest payment the HUB may be responsible for ensuring the Lender is paid in full from the collateral. In some cases the remaining interest under a default may be paid with shares of Securities, in other instances shares of Securities held as collateral may be sold to pay the interest. In other situations the HUB may be responsible to make sure that the Issuer-Borrower has insurance to pay the defaulted cash interest.

### Mediation Roles of the HUB

The HUB may optionally help reduce any potential disputes arising between the Issuer-Borrower and the Lender. This may be performed by ensuring both parties understand the terms of the agreement. In cases where disagreements do arise the HUB may facilitate dispute resolution including providing access to arbitration.

### Advantages of the HUB

The HUB described above has several advantages over existing systems. A few of the benefits are discussed. The HUB can potentially lower the long term cost of capital to less than 2%. The least expenses long term cost of capital had previously been debt financing but even that has historically been more than 2% and was associated with substantial risk of having to repay the loan (ie default). Convertible bonds were invented in part to increase rewards to investors and to reduce the default risk, as in some cases the cash due could be converted to shares. However the cost of capital in convertible bonds increases because equity investors require higher rates of returns than bond holders.

Equity securities can be borrowed inexpensively, typically around 1% per annum based on the cash value of the Securities borrowed, as there is little intrinsic value of holding a share between the time of purchase and the time of sale, except that one may receive dividends. In a Borrow of a Security, the Issuer-Borrower will typically pay the interest as well as any dividend to the Lender.

There is little risk to the Issuer-Borrower or the Lender. The Issuer-Borrower has the option of issuing new Securities to repay the Lender. The Borrower does not have the default risk of a cash loan as can occur with a bond.

The HUB creates value to the Issuer-Borrower because it creates an option for the Issuer-Borrower. The Issuer-Borrower has the option to repay the Lender by buying the shares from the Market, Issuing new Securities to repay the Borrow, or Borrowing additional Securities to repay the Borrow. This option as with most financial options has intrinsic value.

The Borrow described above has additional potential benefits. The periodic interest paid as well as any cost related to appreciation of the share price of Security being repaid at the end of the Borrow may be tax deductible. This tax deduction can possibly offset earnings and could enhance post tax cash flow. The Borrow can help provide low risk, low cost financing for business expansion (for example new factory, new marketing campaign, new mining/oil exploration operation). The Issuer-Borrower can delay issuing new Securities (for repaying the loan or any other purpose) until the business expansion has matured and the Issuer-Borrower becomes cash flow positive. From an accounting point of view, this allows the increased cash flow or earnings to be matched with the increased share float. If the share float is increased (because a company issues new shares instead of Borrowing Securities as discussed above) before the increased cash flow or earnings, then the cash flow or earnings per share will decline.

One skilled in the art after reading this specification will know how to compare the Security Borrow to other types of financing (as in the non-limiting examples of debt, equity issue) on the Issuer's cost of capital, balance sheet, cash flow, earnings and taxes.

### Computerized System

The HUB will contain a computerize system to perform some or all of the functions listed above. A non-limiting example of the computer system of the HUB is included below.

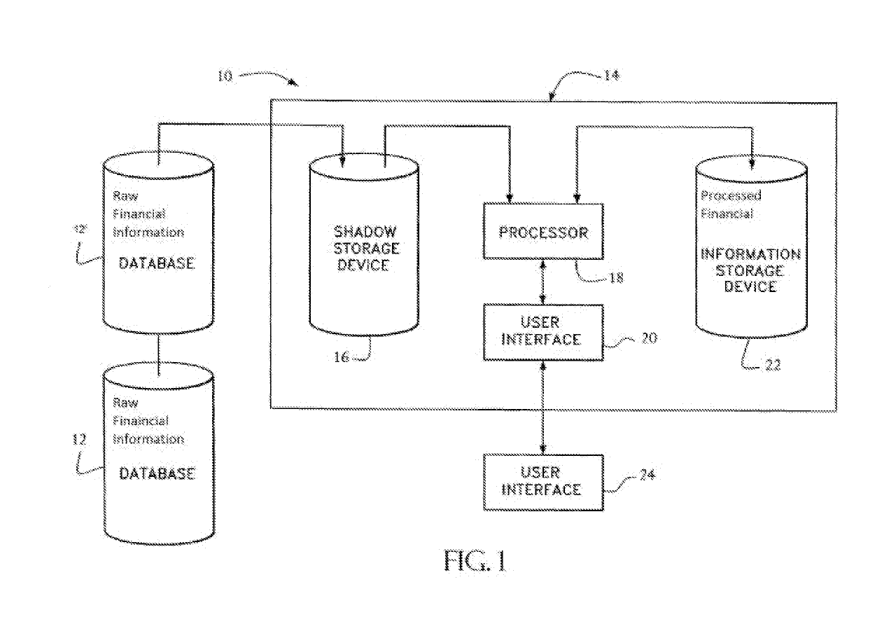

Referring to the drawings, wherein like references indicate like elements throughout the several views, there is shown in FIG. 1 a first system 10 constructed in accordance with the present invention. System 10 includes at least one raw financial information database(s) 12 and a server. Depending upon the source, the raw financial information database(s) 12 may be accessed by server 14 free of charge or for a fee. Raw financial information database(s) 12, preferably contains large amounts of data regarding financial information on at least one of the following: potential Issuer-Borrowers and or their Securities, potential Lenders. Financial information regarding Issuer-Borrowers, their Securities, and potential Lenders may be found on the same database, as shown in FIGS. 1-3, or on separate databases (nor shown), or in a combination of both.

As used herein “Raw” financial information is financial information before the computations and or data compilations described above. The “Raw” financial data may be the results of previous computations as in the non-limiting example of quarterly or annual sales which have been compiled from individual sales throughout the quarter or year. The following are non-limiting examples of Raw data. Raw data may include data available from commercial or public databases on potential Lenders who control shares of Securities and or the number of shares they control before they have committed to lend a set number or range of shares according to specific terms to an Issuer-Borrower. Raw data can include financial information on public companies that are potential Issuer-Borrowers. Raw data may also include information on previous finance deals including possibly previous Security Borrow deals.

Referring to the diagrams of the system, server 14 preferably includes a shadow storage device 16, a processor 18, a user interface 20 and an processed financial information storage device 22 containing compiled or processed financial information. Shadow storage device 16 gathers and stores financial data received from raw financial database(s). Processor 18 may be any computer processing means suitable for executing the operations of the present method as described hereinafter. User interface 20 may include any suitable input/output (I/O) equipment. Processed financial information storage device 22 stores financial information that is generated by processor 18 responsive to analysis of the financial information stored in shadow storage device. The shadow and processed financial information storage devices 16, 22 may be any memory devices capable of storing large amounts of information. Lastly, system 10 includes a user node 24 for interfacing with user interface. User node 24 is preferably any commercially available personal computer, computer terminal, workstation or the like which can exchange information with user interface 20 in the manner well known in the art.

Through operation of system 10 and the other systems described herein, the data extracted from the raw financial database is analyzed by suitable programming of processor 18 to produce useful processed financial information that is storable in an processed financial information storage device. For example, the processed financial information storage device may store information on potential Issuer-Borrowers, potential Lenders, price the Market is likely to buy the Borrowed Security, and financial information discussed above related to how likely the Security Borrow is to being a success. The process information may include, as in the following non-limiting examples, information pertaining to a specific deal or proposed deal or contemplated deal. Processed information may include the number of shares one or more potential Lenders is willing to lend at a specific interest rate or range of rates or has already lent. The processed information may include information on interest payments already paid, as well as information on dates when the shares are to be returned as well as other specific information on a pending or active Security Borrow transaction. The processed financial information may also include information for marketing material, contract terms, future interest payments and day due, financial statements, and or disclosures to regulatory agencies like FINRA or SEC regulated to a Security Borrow.

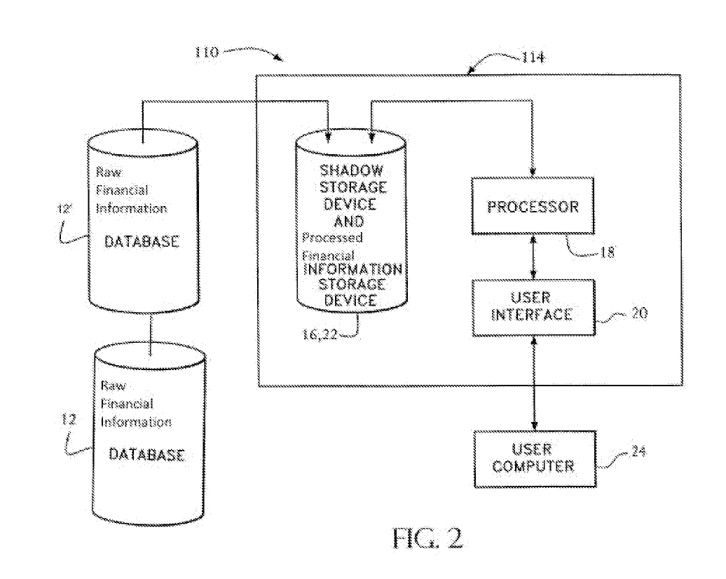

Returning to the drawings, FIG. 2 represents a further preferred embodiment of a system according to the invention identified by reference numeral 1. System 110 is constructed and functions substantially similarly to system 10 of FIG. 1, with the exception being that the shadow storage device 16 and the processed financial information storage device 22 of system 10 are integrated into a single shadow storage device and processed financial information storage device 16, 22 on server 114.

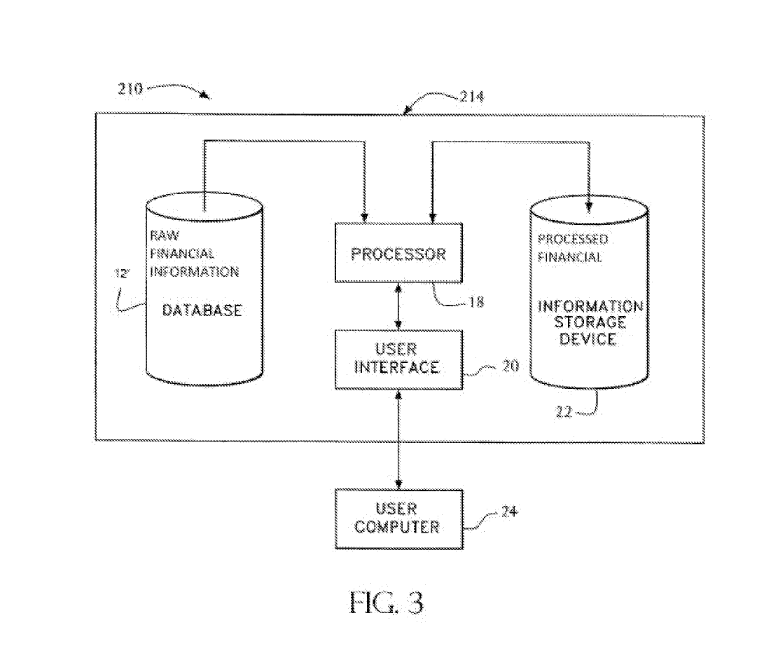

FIG. 3 represents a further preferred embodiment of a system according to the invention identified by reference numeral 2. System 210 also is constructed and functions substantially similarly to system 10 of FIG. 1. However, unlike systems 10 and 110, system 210 draws its raw financial data from an internal, rather than an external source; that is, server 214 of system 210 directly supports raw financial information database(s). System 210 graphically depicts a situation wherein a holder of a substantial body of financial data may itself analyze such data using processor 18, and create one or more processed financial information databases that may be stored on processed financial information storage device 22.

Exemplary users of system 210 may include, the non-limiting examples: of individuals, a corporation, partnership, potential Issuer-Borrowers, potential Lenders, investment banks or bankers, custodians and or custodian banks, stock brokers, traders, stock brokerage companies, stock exchanges, mutual funds, pension funds, hedge funds, insurance companies and contractors or consultants to any of the above. Although illustrated as separated devices, it is also contemplated that raw financial information database(s) 12, and processed financial information storage device 22, may be integrated into a single storage device, or they may each be a plurality of interconnected nodes.

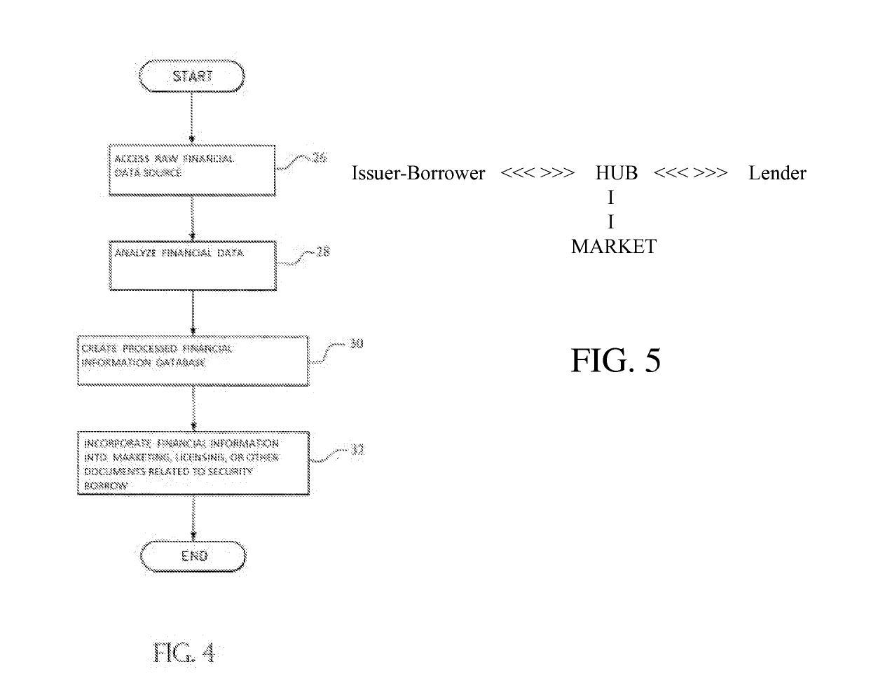

FIG. 4 is a flow-chart that embodies the essential method steps of the present invention that are executed by each of systems 10, 110 and 210. At step 26, the raw financial information database(s) 12 are accessed by server(s) 14, 114, 214 (at a fee or free of charge) to obtain desired data there from. In systems 10 and 110, the raw financial information database(s) 12 are external to the servers 14 and 114. Hence, servers 14 and 114 desirably store the data received from database(s) 12 in shadow storage devices. Server 214, by contrast, accesses its internal financial information database(s) 12 for the desired data.

The desired financial data having been accessed, the processor 18 of systems 10, 110 and 210 then analyzes the data to perform the functions and calculations described above, as indicated at step 28. At step 30, the processor 18 further processes the raw financial information data to create useful processed financial information, such as any of the kinds mentioned above that is useful for a Security Borrow. The processor 18 then stores the processed financial information as one or more databases in the processed financial information storage device 22.

According to presently preferred embodiments of the invention, the data retrieved from the raw financial information database(s) 12 is processed and analyzed by a centralized processor 18 on server 14, 114 or 214, and the analyzed data is stored at an processed financial information storage device also supported by server 14, 114 or 214. Alternatively, the proprietors of servers 14, 114 or 214 may license proprietary software to users of node 24 that may perform the functions of processor. Such software may be loaded onto the user node 24 to execute the financial data analyzing and other processing functions of processor 18 described above, and the generated useful financial information may be stored at the user node. In any case, servers 14, 114 and 214 can be directly connected by a user interface 20, such as a modem.

It will be understood that the servers 14, 114 and 214 may also be indirectly connected to a user node 24 via one or more other servers, a central computer or other system designed to link computers, nodes or other processing machines. Ideally, the information should be transferred digitally between servers 14, 114 and 214 and user node. Alternatively, however, it can be transmitted in analog form by a modem along standard telephone lines. It will be further understood that the information can also be transferred by disk, CD-ROM or other electronic media, or printed and then scanned in, or alternatively, manually re-keyed.

Preferably, the user node 24 and associated printers (not illustrated) are sufficiently sophisticated to organize and print all information generated by the systems 10, 110 and 210 in virtually any desired format and on essentially any desired printable medium that may be printed by the printers.

Users of systems 10, 110 and 210 may include the non-limiting examples: of individuals, a corporation, partnership, potential Issuer-Borrowers, potential Lenders, investment banks or bankers, custodians and or custodial banks, stock brokers, traders, stock brokerage companies, stock exchanges, mutual funds, pension funds, hedge funds, insurance companies and contractors, consultants, or agents to any of the above. The users may use the information to develop Security Borrow transactions described above. The systems 10, 110 and 210 and the methods depicted in FIG. 4 are especially useful for creating contracts and financial information/documents for Security Borrows. The systems and devices of the present invention can assist in preparing information for Security Borrow transactions. Such information can include marketing materials to solicit potential Issuer-Borrowers or potential Lenders. Preferably, systems 10, 110 and 210 are capable of formatting the financial information data, such that it is suitable for incorporation into contracts, financial statements, disclosures to regulatory agencies such as FINRA or SEC.

The owner/licensor or licensee may commercialize the financial information in the processed financial information storage device 22 by selling or licensing the proprietary information to a third party. The third party communicates with system 10, 110 or 210 through user node. The user node interfaces with user interface 20 to make requests for information to, and to receive information from, the processor 18 of server 14, 114 or 214. Interpretation of the received information may be performed by the third party, an independent contractor, the owners or licensees of server 14, 114 or 214 or the owner(s) or licensees of the raw financial information database(s) 12.

What is claimed:

1. A method to assist in raising capital for an issuer of equity securities as well as generating interest payments for holders of equity securities issued by said issuer,
said method comprises, use of a computerized HUB system including a computerized database and computer-readable code encoded on a computer readable non-transitory medium and which, when executed by a computer processor in the computerized HUB system, performs instructions to:
i) identify one or more shares of the equity securities previously issued by the issuer that may be available for the issuer to borrow,
ii) create a computerized database with data estimating and or documenting the number of equity shares that one or more potential lenders is willing to lend to the issuer at an interest rate or range of interest rates,
wherein the interest rate reflects collateral comprising at least one of the following: unissued shelf registered fungible shares, fungible treasury shares or a promissory note to issue fungible shares as repayment,
wherein the interest rate reflects the use of the proceeds to provide financing for the issuer, and
wherein the interest rate reflects the ability of the issuer borrower to repay the loan by issuing fungible shares to use as repayment.

2. The method of claim 1, further comprising instructions to create a computerized database that stores information for at least one lender on the number of shares lent or agreed to be lent and or payments received or to be received from the borrower.

3. The method of claim 2, further comprising instructions to identify that an acceptable excess of equity shares exist for the issuer to borrow in case a lender demands its share back before the end of the desired loan.

4. The method of claim 2, further comprising instructions to calculate an turnover rate or ratio of said shares.

5. The method of claim 4, wherein the turnover rate or ratio relates specifically to existing holders willing to lend shares to the issuer-borrower.

6. The method of claim 2, further comprising instructions to assist in deriving an interest rate for the shares to be borrowed by the issuer-borrower.

7. The method of claim 2, further comprising instructions to store data on and/or calculate interest payments received and/or due in the future, wherein the interest payment is based on value of the equities being lent at the time of the loan.

8. The method of claim 2, further comprising instructions to store data on and/or calculate interest payments received and/or due in the future based on an interest payment which varies during at least a portion of the duration of the loan and is based on the fluctuation value of shares being lent.

9. The method of claim 2, further comprising instructions to identify additional shares to borrow in a case where a lender requests its shares back prior to the scheduled end of the loan or the borrower needs to borrow additional shares.

10. The method of claim 9, further comprising instructions to store data on and/or calculating interest payments received and/or due in the future for the loan of the new shares leant or to be leant.

11. The method of claim 2, wherein the shares borrowed are controlled by multiple lenders but the terms of the borrowing are standardized.

12. The method of claim 2, wherein the interest rate reflects covenants regarding priority in which the lenders can request lent shares back, and wherein the covenant requires obtaining lent shares from other borrowers before demanding shares from the issuer-borrower.

13. The method of claim 2, wherein the interest rate reflects an agreement to lend additional shares in the future according to an agreed upon term(s).

14. The method of claim 2, further comprising instructions to calculate and/or store data regarding at least one of the following: amount of interest payment due, date or time interval the interest payment is due, and date the borrowed shares are to be repaid.

15. The method of claim 1, further comprising instructions to calculate and/or store data regarding the decreased cost of capital and/or savings to the issuer that is expected from employing the security borrow and short sale.

16. The method of claim 1, further comprising instructions to calculate and/or store data regarding the issuer's capital structure using the security borrow compared to one or more alternative forms of capital raises comprising: debt raise, equity sale, convertible bond sale, warrant sale.

17. The method of claim 1, further comprising instructions to calculate and/or store data regarding the expected effect the equity borrow will have on share price and or earnings per share of the issuer-borrower.

18. The method of claim 1, further comprising instructions to calculate and/or store data regarding the expected effect of the security borrow on taxes of the issuer-borrower.

19. The method of claim 2, further comprising instructions to sell the borrowed securities and provide proceeds from the sale of the borrowed securities to the issuer of the securities.

20. The method of claim 2, further comprising instructions to purchase shares from the market to repay the loan.

21. The method of claim 2, further comprising instructions to store data on the identities of one or more lenders who retain voting rights that accompanies one or more equity shares they are lending.

22. The method of claim 2, wherein the interest rate on the borrow is lower than the cost of capital associated with issuing of new equity, said method results in a reduced risk of default compared to comparable amount of debt financing, the borrow is initially non dilutional to existing share holders and the interest rate is equal or lower than the issuer's borrow rate for cash for the same amount of cash proceeds and same intended duration of the loan.

23. The method of claim 1, wherein the borrow is for a duration of at least 6 months.

24. The method of claim 2, wherein the interest rate reflects a contract to provide a credit line of shares that can be borrowed, where the issuer-borrower can borrow a range of shares over a time range.

25. The method of claim 2, wherein unissued shelf registered shares are used as collateral.

26. The method of claim 2, wherein the duration of the borrow is scheduled according to a contract for at least one year and the issuer-borrower must pay the lender a financial penalty if the loan is repaid early.
